(19) United States
(12) Patent Application Publication
(10) Pub. No.: US 2026/0156200 A1
(43) Pub. Date: Jun. 4, 2026

(54) SMART NOTIFICATION MANAGER

(71) Applicant: Stripe, LLC, South San Francisco, CA (US)

(72) Inventors: Arun DAS, Fremont, CA (US); Sachin DIXIT, Cupertino, CA (US)

(21) Appl. No.: 18/966,096

(22) Filed: Dec. 2, 2024

(51) Int. Cl. H04L 67/55; G06F 21/62; G06F 40/205; G06F 40/30

(52) U.S. Cl. CPC H04L 67/55; G06F 21/6218; G06F 40/205; G06F 40/30

(57) ABSTRACT

A notification manager can receive a request for a notification or alert from a user in a natural language interface and extract user intent and derive data sources from the request. The notification manager can store the request and execute the request periodically to determine if any conditions associated with the request are met and if so, generate an alert or notification to the user according to the request.

### TECHNICAL FIELD

The present description generally relates to utilizing natural language processing to establish notifications, alerts, and reports related to various data sources.

### BACKGROUND

Typically, users have little flexibility in requesting ongoing reporting or alerts related to data from various data sources. Such considerations are usually established at the build phase of a system, limiting the user's ability to create custom notifications based on unique needs and circumstances. As a result, users in such situations often resort to lengthy processes involving multiple manual steps to obtain the information needed. This may include gathering data, transforming it in a spreadsheet program using pivot tables and formulas, and applying various rules, which can be time-consuming and inefficient. These inefficiencies not only lead to delays in decision-making but may also impact financial performance and customer satisfaction.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates an example network environment in which the subject technology may be implemented, in accordance with one or more embodiments.

FIG. 2 depicts an example electronic device that may implement the subject technology, in accordance with one or more embodiments.

FIG. 3 illustrates a data flow diagram for an organizational server running an application for processing requests from users, in accordance with one or more embodiments.

FIG. 4 depicts a flow diagram of an example process for processing requests from users, in accordance with one or more embodiments.

FIG. 5 depicts a flow diagram of an example process for processing previously stored requests from users, in accordance with one or more embodiments.

FIG. 6 depicts an example electronic system with which aspects of the present disclosure may be implemented, in accordance with one or more embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In one or more embodiments, structures and components are shown in block diagram form in order to avoid obscuring the concepts of the subject technology.

Complex information systems may track various metrics or information, usually across one or more databases. In business entities with different customers such information may be related to each of the different customers. In technically oriented businesses, such information, for example, may be related to software products, billing information, data storage information, data content information, sales information, commissions information, scheduling information, and so forth. In financially oriented businesses, such information, for example, may be related to financial transactions, account usage limits, billing, profitability, costs, balance or position information, available accounts, withdrawals, deposits, and so forth. Other businesses may use other types of data. Known solutions for monitoring such information data are limited..

Aspects of the subject technology provide a way of giving stakeholders in one or more data sources the ability to initiate customized alerts or reporting tools using a natural language interface. A user, for example, can request an alert, report, or notification on some aspect of data in one or more databases and the subject technology can determine how to fulfill the request, whether the user has access to the data, and schedule the fulfillment of the request in an application execution store. When the request results in a notification or report, then the request can be deemed to be filled, or if the request is a repeating request, the request can remain in a execution store until it is executed again.

Aspects of the subject technology determine a user's intent in the request, for example, whether the user is requesting an alarm notification, a status notification, a reporting notification, a periodic execution, a limit based execution, and so forth. If the request is beyond the system's ability to fulfill, such as a request for purging a transaction or a request for editing some information, then the user may receive a message indicating that the request contained an error or that the request could not be filled. Aspects of the subject technology can also determine a data area associated with the request. These data areas are associated with different data sources. For example, if the request concerns transactions against a purchase order, then the data sources may include transaction information and purchase order information. Aspects of the subject technology can also determine which data subjects are related to the request. For example, if the request is for information for a purchase order for a particular business entity of a customer, then the data subjects may include the business entity, the customer, and the user making the request. Aspects of the subject technology can utilize the data areas and the data subjects to determine if the user making the request has permission to access the data required to fulfill the request. Aspects can also determine, based on the data area and the data subjects, a pre-defined connector that can be used to generate an intermediate data source to analyze to fulfill the request.

Aspects of the subject technology may utilize natural language processing (NLP), such as a large language model (LLM) to receive the user request and extract information from the user request to categorize the request and determine what data sources are needed to fulfill the request. At some time after the request is authorized and stored in an execution store for later execution, the request can be retrieved from the execution store by a watcher process and executed, where the execution utilizes a data connector related to the request to build an intermediate data source, which is provided to a natural language engine along with the request.

Aspects of the subject technology can utilize a natural language (NL) engine to analyze the intermediate data source and the request, including, if applicable applying the data from the intermediate data source to a higher function math plugin for calculating conditional information, if needed. The NL engine can determine that conditions associated with the user request are satisfied and provide an output which is then passed on to the user, for example, by any communications process configured by the user, such as by a text message or SMS message, an email, a message via a work communications platform, or the like, and so forth.

The subject technology advantageously provides a natural language interface for a user to request data or reports at certain times or when certain conditions are met. The interface allows the user to do so without needing to reprogram any module to obtain the results. Utilizing the NL engine simplifies programming tasks. The subject technology also improves functional aspects of a system for monitoring data elements. A task store can be used to store user requests and run them periodically. Further, because each request is processed through the NL engine at runtime, any re-training or updating of the NL engine can be effective for each previously stored request in the store.

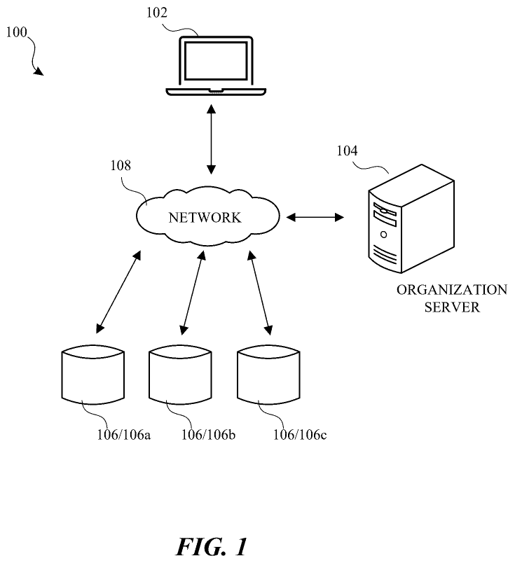

FIG. 1 illustrates an example network environment 100 in which the subject technology may be implemented, in accordance with one or more embodiments. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, an organization server 104, and one or more database servers 106 such as database server 106a, 106b, and 106c. The network 108 may communicatively (directly or indirectly) couple one or more of the electronic devices 102, the organization server 104, and the one or more database servers 106. In one or more embodiments, the network 108 may be an interconnected network of devices that may include, or may be communicatively coupled to, the internet.

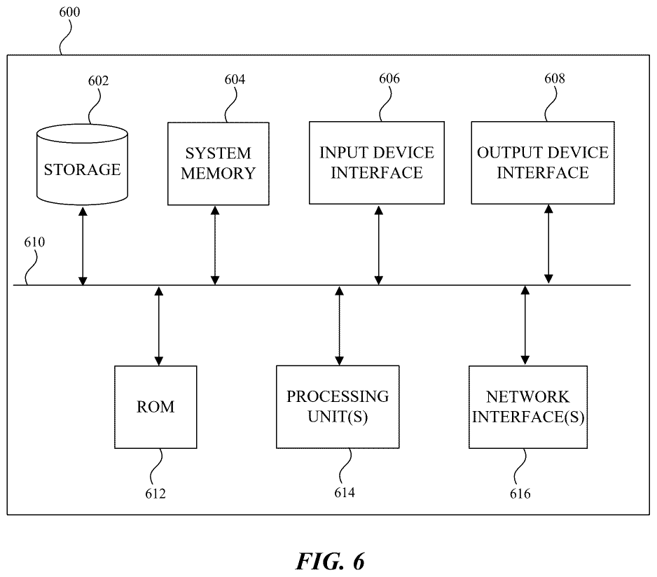

For explanatory purposes, the network environment 100 is illustrated in FIG. 1 as including the electronic device 102, the organization server 104, and the one or more database servers 106; however, the network environment 100 may include any number of electronic devices and/or any number of servers communicatively coupled to each other directly or via the network 108. In addition, the various systems of FIG. 1 may be, and/or may include all or part of, the electronic system discussed below with respect to FIG. 6.

The electronic device 102 may be under the control of a user with authorization to access records associated with the organization server 104. The electronic device 102 while operating as specified herein may have authorization to interact with the organization server 104 and/or the database servers 106, for example, such as through an account login or other access credential. Thus, the electronic device 102 is used to access one or more management applications providing functionality and/or an interface for accessing the subject technology. The electronic device 102 may be, for example, a wearable device (such as a watch, a band, and the like), a desktop computer, a portable computing device (e.g., a laptop computer), a point of service terminal, a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a laptop computer. The electronic device 102 may be associated with one or more accounts, credentials, or any other identity information registered with the organization server 104 and/or the one or more database servers 106, in accordance with some implementations.

The organization server 104 may be and/or may include, for example, one or more servers that host or facilitate an application that utilizes an NL engine and application logic to provide reporting, notification, and alerting services and management related to the data stored in one or more databases. As an example, the organization server 104 may include an interface that allows a user to input a natural language request for information relating to data in the one or more databases when a condition is met or after a periodic time has lapsed, as an example. The organization server 104 may further include application logic for processing the request and managing a watcher program to retrieve requests and execute them to determine if the condition and/or periodic time has been met. The organization server 104 may further include application logic to allow a user to retrieve and manage pending requests. In some embodiments, the organization server 104 may be implemented as service of one or more servers. Such one or more servers or the organization server 104 may be, and/or may include all or part of, the electronic system discussed below with respect to FIG. 6.

The one or more database servers 106 may each be and/or may include, for example, one or more servers that host or facilitate a database service that may be used by one or more entities, and may store and organize data related to the electronic device 102 and/or organization server 104. The one or more database servers 106 may be implemented as service of one or more servers, such as the organization server 104, or one or more other servers. Such one or more other servers or the one or more database servers 106 may each include all or part of, the electronic system discussed below with respect to FIG. 6.

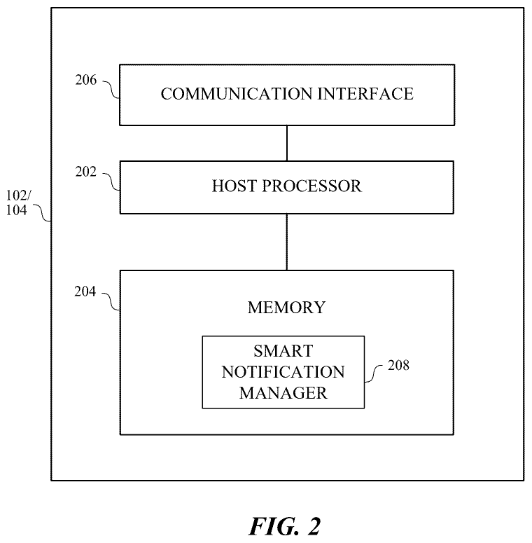

FIG. 2 depicts an example electronic device 102 or organization server 104 that may implement the subject technology, in accordance with one or more embodiments. For explanatory purposes, FIG. 2 is primarily described herein with reference to the electronic device 102 or organization server 104 of FIG. 1. However, this is merely illustrative, and features of the server of FIG. 2 may be implemented in any other electronic device for implementing the subject technology and/or any other server for implementing the subject technology, such as the database servers 106. Not all of the depicted components may be used in all embodiments, however, and one or more embodiments may include additional or different components than those shown in FIG. 2. Variations in the arrangement and type of the components may be made without departing from the spirit or scope of the claims as set forth herein. Additional components, different components, or fewer components may be provided.

The electronic device 102 or organization server 104 may include one or more of a host processor 202, a memory 204, and/or a communication interface 206. The host processor 202 may include suitable logic, circuitry, and/or code that enable processing data and/or controlling operations of the electronic device 102 or organization server 104. In this regard, the host processor 202 may be enabled to provide control signals to various other components of the electronic device 102 and organization server 104. The host processor 202 may also control transfers of data between various portions of the electronic device 102 or organization server 104. The host processor 202 may further implement an operating system or may otherwise execute code to manage operations of the electronic device 102 or organization server 104.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). The memory 204 may include smart notification manager 208 including executable programs, routines, and services that provide the functions described herein. The specific implemented smart notification manager 208 may vary based on whether the memory 204 is in implemented in the electronic device 102 or the organization server 104. The memory 204, for example, can include logic and/or programming instructions for implementing part or all of the subject technology corresponding to the smart notification manager 208.

The communication interface 206 may include suitable logic, circuitry, and/or code that enables wired or wireless communication, such as between the electronic device 102, the organization server 104, the one or more database servers 106. The communication interface 206 may include, for example, one or more of a Bluetooth communication interface, an NFC interface, a Zigbee communication interface, a WLAN communication interface, a USB communication interface, a cellular interface, or generally any communication interface.

In one or more embodiments, one or more of the host processor 202, the memory 204, the communication interface 206, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

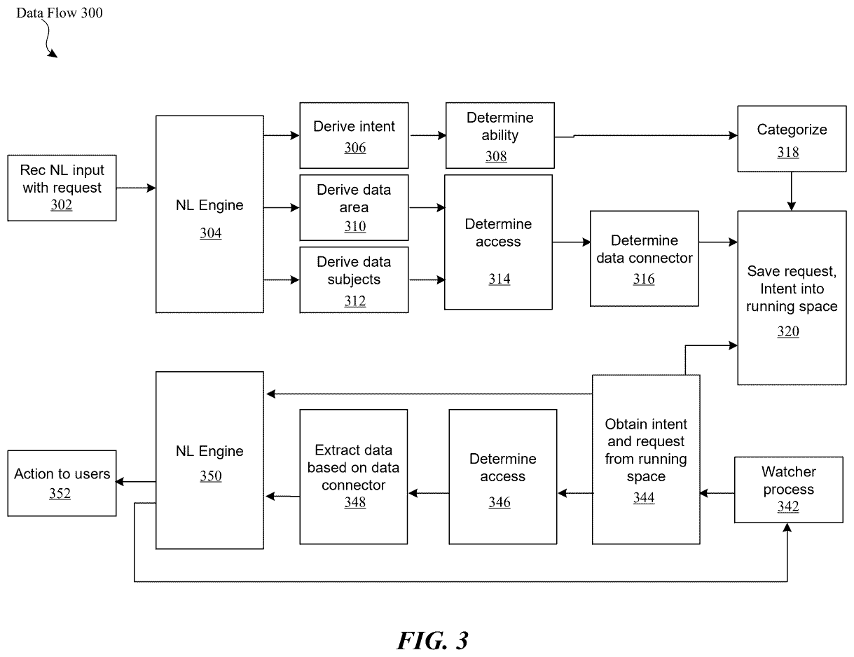

FIG. 3 illustrates a data flow diagram 300 which receives an input request from a user and establishes a job request in an execution store, then executes the request and provides a notification when the request results in a notification event. The data flow diagram 300 takes place primarily within the organization server 104 but may send and/or receive data from the electronic device 102 and from the one or more database servers 106. Although the discussion of the data flow diagram 300 proceeds below describing the data flow from block to block, it should be understood that flow can be performed in parallel as appropriate or may flow out of the order described where the associated processes allow for the data flow to differ. Although specific examples may be used to help elucidate the disclosure, it should be understood that the data management described below can be applied to any situation where a user would want a notification on data contained in one or more databases.

At element 302, a natural language input is received, for example at the organization server 104, with a request from a user via, for example, electronic device 102. The user may provide the request via a microphone interface, speaking the request, or via a textual input, typing the request, in a user interface. The user may request, for example, an alert based on the user's needs that best aids in making a decision about a business situation. The input may be provided in natural language in any language supported by the NL engine that will be used in processing the input. For example, one request may include “Send me details including revenue, profitability, and cost structure on a weekly basis.” Another might be “Send me a newsletter containing the following information on a monthly basis, budget vs. actual performance, financial projections.” Still another might include “Alert me when there is less than 15% fund available on <PO_NUMBER>,” where “<PO_NUMBER>” corresponds to an actual purchase order number.

At element 304, the request is provided to a natural language (NL) engine. The NL engine of 304 may correspond, for example, to a large language model (LLM), which has been trained on a large corpus of data to provide natural language processing. After providing the request to the NL engine, the intent of the request can be derived at element 306. The intent can be derived, for example, by asking the NL engine if the request corresponds to an alert, a notification, or a report. The intent can also be derived by asking the NL engine to determine what the intent of the request is and the NL engine may respond, thereby providing intent information for the request. The intent can be derived also without the NL engine. For example, the intent can be derived based on keyword analysis or heuristics associated with the request.

At element 308, the intent of the request that was previously determined at element 306 can be checked to determine if the system has the ability to fulfill. For example, the system may be limited to a read-only system such that the underlying data is not affected. Thus, an intent that indicates that the user is wishing to alter the underlying data may result in an error returned to the user. In another example, the system may determine that the request includes an intent to return a report or alert via a text message to the user and the system may not have access to the requested communication channel, which may result in an error returned to the user. In another example, the system may determine that the request includes an intent to write a report or provide an alert in a manner which the system can perform, in which case, the flow can continue. The intent can also be understood as corresponding to a request-type from the user, the request-type, for example, corresponding to an alert request type, a notification request type, or a reporting request type, and so forth.

At element 310, a data area for the request can be derived from the request. The data area for the request can provide a context for the request and determine which information sources need to be accessed to fulfill the request. The data area can also correspond to a metric such as “budget” or “profit” or “transactions” which can be used to determine which data sources are needed to be accessed to fulfill the request. For example, the data area can identify which functional areas are implicated by the request and identify data sources related to that functional area. Given the above examples, the functional areas for the first example to “Send me details including revenue, profitability, and cost structure on a weekly basis,” can correspond to various accounting sources like sales and costs. Such accounting sources may be spread out geographically and/or logically among various regions of the state, country, or world. For the second example, to “Send me a newsletter containing the following information on a monthly basis, budget vs. actual performance, financial projections,” the functional areas may correspond to data sources for budgeting information and expense information. For the third example, to “Alert me when there is less than 15% fund available on <PO_NUMBER>,” the functional areas may correspond to purchase order purchasing. The various data areas, such as functional areas of the organization can be pre-defined by developers and provided to the NL engine for the NL engine to use as context to provide a response. The request can include a condition associated with the metric such as a request for an alert when profits exceed 10% of costs, or a condition can be derived or understood from the request.

At element 312, data subjects for the request can be derived, such as what entities or aspects of the request can be used as filters or search terms to narrow the request. The data subjects, for example, can correspond to particular business entities related to the request. In a complex information system, such data subjects can further narrow which data sources are going to be used or can provide a filter to provide a more pertinent results related to the request. Given the above examples, the data subjects for the first example to “Send me details including revenue, profitability, and cost structure on a weekly basis,” can correspond to the business entity associated with the user making the request. For example, if the user is a manager in a particular regional sales office, the data subjects can be filtered based on the particular regional sales office. For the second example, to “Send me a newsletter containing the following information on a monthly basis, budget vs. actual performance, financial projections,” the data subjects may include a business entity for which the user is affiliated. For the third example, to “Alert me when there is less than 15% fund available on <PO_NUMBER>,” the data sources may include the PO number and the business entity associated with PO number. In some implementations, the data subjects can be determined, at least based in part, on a level of access associated with the user making the request. For example, an organization-wide manager may have access to many more data sources, and so the data subjects associated with the request can be determined to be at a broader scope than a request, for example, by a manager of a local location of a business. Thus, the data subjects can include scoping information related to the user.

At element 314, the system can determine, based on the data area from element 310 and the data subjects from element 312, whether the user has access to the requested information. For example, the credentials of the user may not provide access to the data areas needed to obtain the information. The access may also be determined based on the data subjects from element 312. For example, the user may not have access to some of the data sources provided by element 310, but when filtered by the data subjects identified from element 312, the user may have access to a subset of the data sources.

At element 316 a data connector is determined based on the data area from element 310 and data subjects from element 312. The data connector may include, for example, a set of pre-determined instructions to combine data sources to accomplish the request. For example, if the data sources correspond to SQL databases, the data connector can include SQL query commands to combine the output of queries on different tables using substituted information from the data subjects to form an intermediate data source. As a specific example, the data connector may specify a UNION or JOIN between one or more tables. Given an orders table and a costs table, a query corresponding to a data connector may be formatted in a manner such as:
SELECT Orders.price, Costs.cost FROM Costs
JOIN Orders ON Costs.<ItemID>=Orders.<ItemID>
WHERE Orders.location=<LocationID>,
   where “<ItemID>” and “<LocationID>” in this example are derived from the data subjects. Given the above examples, the data connector for the first example to “Send me details including revenue, profitability, and cost structure on a weekly basis,” can correspond to a data connector that combines revenue data sources, profitability data sources, and cost data sources, which are limited or filtered in the data connector by the data subjects information derived at element 312. For the second example, to “Send me a newsletter containing the following information on a monthly basis, budget vs. actual performance, financial projections,” the data connector can correspond to a data connector that combines budget data sources and revenue data sources, which are limited or filtered in the data connector by the relevant data subjects information derived at element 312, e.g., filtered to a specific business unit or location. For the third example, to “Alert me when there is less than 15% fund available on <PO_NUMBER>,” the data connector may correspond to a data connector that retrieves information from the purchase order database, but limited specifically to the PO number provided as a data subject for the request derived at element 312.

At element 318, based on the intent a request-type is determined. For example, if the intent was report, then the request-type can correspond to a report request-type. If the intent was an alert, then the request-type can correspond to an alert request-type. The request-type can also be categorized based on whether the request is a one-time request or a periodic request. For example, given the above examples, the data connector for the first example to “Send me details including revenue, profitability, and cost structure on a weekly basis,” can correspond to a request-type that is a periodic request. Once stored, the request can be executed “on a weekly basis” until such time as the user cancels the request. The user could also specify an end date or a number of times the request should execute within the request. For the second example, to “Send me a newsletter containing the following information on a monthly basis, budget vs. actual performance, financial projections,” similar to the first example, the request can be executed “on a monthly basis.” For the third example, to “Alert me when there is less than 15% fund available on <PO_NUMBER>,” the request type is conditional and once executed (e.g., the condition is met), it can be marked fulfilled and eventually purged from the execution store of requests.

At element 320, the request and request-type (e.g., intent, conditional vs. periodic) can be saved into an execution store for the reporting application. In addition, if the request is periodic, for example, then a next execution date can be stored along with the request. In addition, an indication of the data connector can also be saved as well as any other derived information, for example, from element 310 and/or element 312. The indication of the data connector, for example, can be a pointer to a data connector in a database of data connectors that can be executed to combine data sources in a manner described above.

Optionally, the request can be processed immediately in some implementations. If the request is a conditional request and the condition is not met, however, the request can be processed again at a later time. A watcher process 342 can loop through a data flow of retrieving stored requests and executing them. In the case where the request-type is conditional for example, the data flow can retrieve a request at regular intervals, for example, every 10 minutes, every hour, every 12 hours, every day, every three days, every week, and so forth, and execute the request at such intervals to determine if the condition has been met. When the condition is met then an action can be taken, such as an alert, notification, or report. In the case where the request-type is periodic, the watcher process can execute the request according to the periodic schedule set forth in the request and according to the details provided in the request-type determined at element 318.

When a request is executed by the watcher process 342, first at element 344, a request and intent corresponding to the request are obtained from the execution store for the application. In some implementations, the associated data sources, data subjects, and/or data connector may also be obtained from the execution store. In other implementations, the data flow can proceed to elements 310, 312, and 316 again to derive the data area, the data subjects, and the data connector.

At element 346, the system can determine whether the user associated with the request still has access to the data sources related to the request. Recall that the access was determined at element 314. Access is determined again at element 346. In some instances, for example, a user can lose access to one or more data sources associated with the request.

At element 348, data based on the data connector is extracted from the data sources into an intermediate data structure. The data connector, for example, can execute a query to combine data from the data sources which is filtered based on the data subjects derived at element 312. For example, given the above examples, the data connector for the first example to “Send me details including revenue, profitability, and cost structure on a weekly basis,” can combine revenue data sources, profitability data sources, and cost data sources, each of which are limited or filtered in the data connector by the data subjects, such as business entity, location, region, country, etc., derived at element 312. For the second example, to “Send me a newsletter containing the following information on a monthly basis, budget vs. actual performance, financial projections,” the data connector combine budget data sources and revenue data sources, which are each limited or filtered in the data connector by the relevant data subjects information derived at element 312, e.g., filtered to a specific business unit or location. For the third example, to “Alert me when there is less than 15% fund available on <PO_NUMBER>,” the data connector retrieves information from the purchase order database which is filtered based on the PO number, the region associated with the purchase order, and so forth.

At element 350, the extracted data and the request can be provided to the NL engine which can then use the request and execute the request against the extracted data. NL engine can be the same NL engine from element 304 or may be a different NL engine. In some implementations, the NL engine may have access to a math plugin so that computations can be performed using the math plugin. Because the extracted data and request are provided to the NL engine each time the request is processed, any updates to the NL engine are advantageously applied to the processing of the request each time the request is run. Thus, as the NL engine continues to learn or understand new features, the results of the requests may obtain greater value to the user.

Given the above examples, the NL engine for the first example to “Send me details including revenue, profitability, and cost structure on a weekly basis,” can provide a report output that includes revenue, profitability, and cost structure from the combined revenue data profitability data, and cost data. In some instances, the math plugin can be used to compare revenue and cost structure to arithmetically determine profitability data. Further, due to the limitations previously applied via the derived data subjects, the resulting report output can be limited to a particular business entity, location, or region associated with the user. For the second example, to “Send me a newsletter containing the following information on a monthly basis, budget vs. actual performance, financial projections,” the NL engine can utilize the extracted data based on the data connector to develop and provide a newsletter utilizing, for example, generative artificial intelligence and the extracted data to compare the budget performance vs. the actual performance. Further, the NL engine can utilize the math plugin to perform arithmetic comparisons between the budge performance and the actual performance for developing the report. For the third example, to “Alert me when there is less than 15% fund available on <PO_NUMBER>,” the NL engine can use the extracted data to determine whether the condition has been met that there is less than 15% funds available on the specified purchase order. If not, then the request is done, and if so, then the system will continue to provide an alert according to the condition.

At element 352, an action can be provided to users according to the output of the NL engine. For example, if a report was generated, then the report can be provided to the user. If a newsletter was generated, then the newsletter can be provided to the user. If an alert was triggered by the satisfaction of the requested condition, then the alert can be provided to the user. The user, for example, can be the user or the user account who originated the request. The action can be provided to the user using a configured communications mechanism, such as email, phone, text address, and so forth.

A log can be created that the request was executed and that the action to user was made. In the case of the third example, if the alert was generated, the request in the execution store (e.g., at element 320) can be flagged as having been satisfied. The request can be purged from the execution store. In the case of other requests a counter can be maintained along with the request and in such cases, the counter can be incremented when the request is processed.

Returning briefly to element 302, in some implementations, the request can be a request to manage all user requests. In such a case, the NL engine can process the request and return to the user all the requests from the watcher process 342 and/or the execution store (e.g., from element 320). The user can subsequently provide an indication to remove or stop a request from further execution or to modify a request to change the frequency or conditions associated with the request. The NL engine at element 304 can process such subsequent requests and cause the execution store to be updated to disable, remove, or modify an indicated request.

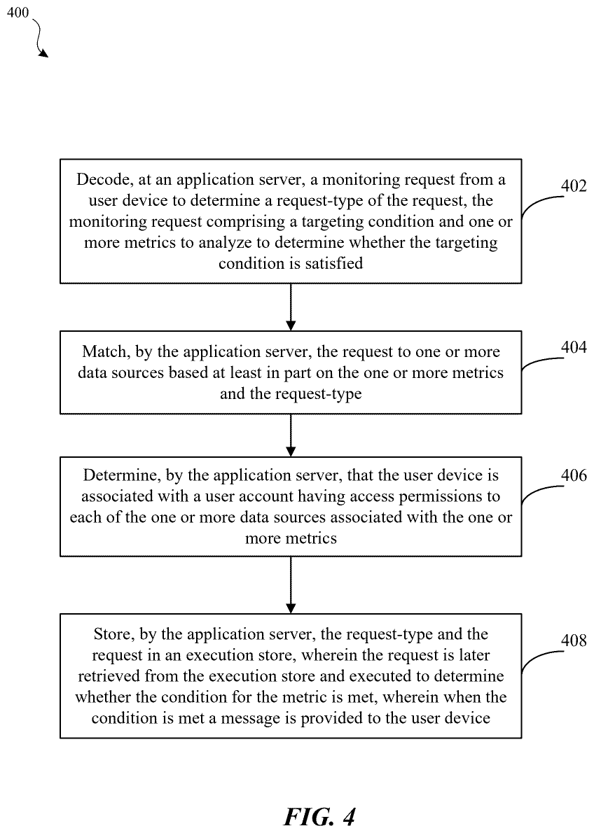

FIG. 4 illustrates a flow diagram of an example process 400 for providing from a server, such as the organization server 104, a mechanism for processing requests from users, in accordance with the subject technology. For explanatory purposes, the process 400 is primarily described herein with reference to the organization server 104. However, the process 400 is not limited to these, and one or more blocks of the process 400 may be performed by one or more other by other suitable devices. Further, for explanatory purposes, the blocks of the process 400 are described herein as occurring sequentially or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, an application server can decode a monitoring request from a user device to determine a request-type of the request. The monitoring request can have a targeting condition and one or more metrics to analyze to determine whether the targeting condition is satisfied. Block 402 can correspond in part to element 306 of FIG. 3. The monitoring request can, for example, correspond a user request to monitor some aspect of a data store for a certain condition. For example, the monitoring request can correspond to example three discussed above, to monitor a purchase order database for a condition involving a particular purchase order. In another example, the monitoring process can correspond to monitoring one or more data stores for logged network load across a network interface. In another example, the monitoring process can correspond to monitoring one or more data stores for day-to-day profitability at multiple locations of a retail storefront. In essence the process 400 can be applied to request a monitoring process for any data store and for any condition related to the data store.

At block 404 of process 400 the application server can match the request to one or more data sources based at least in part on the one or more metrics and the request-type. Block 404 can correspond to element 310 and/or element 312 of FIG. 3. The data sources can be determined based on the request, as described above. Further, the data sources can be scoped or filtered based on the data subjects.

At block 406 of process 400, the application server can determine that the user device is associated with n user account having access permissions to each of the one or more data sources associated with the one or more metrics. Block 406 can correspond to element 314 of FIG. 3, described above. The application server can ensure that the user has access to the data sources so that the request can be processed. If the user does not have access an error message can be returned to the user and the user can reformat the request or seek to obtain the necessary permissions to access the information requested.

At block 408 of process 400 the application server can store the request-type and the request in an execution store, where the request is later retrieved from the execution store and executed to determine whether the condition for the metric is met, and when the condition is met a message is provided to the user device. Block 408 can correspond to element 320 of FIG. 3. The request and request-type can be stored in the execution store. The request can be processed initially as well to determine if the condition is already met. In some instances, a next execution time can be stored along with the request as well as any derived data, such as information regarding data sources, access, data subjects, and so forth, as described above.

Process 400 can further include submitting the request to a large language model at the application server to obtain the request-type, the targeting condition, the one or more metrics, and the one or more data sources, where the large language model was previously trained with a mapping of the one or more data sources. Further metric typing information can be derived from the request-type and the one or more metrics. In some implementations, the metric typing information corresponds to a business unit and a functional area of the business unit, where the one or more data sources are constrained to data sources related to the business unit and the functional area of the business unit. The metric typing information can correspond to the data subjects discussed above with respect to element 312 of FIG. 3. The metric typing can help the system determine which data sources are needed and/or can be used in requesting data from data sources to obtain a subset of data according to the metric typing information.

Process 400 can further include categorizing the request as being event-based or time-based, and the categorization of the request can be stored along with the request in the execution store. If the request is event based, then the request can be executed periodically to determine if the event has occurred. If the request is time-based or periodic, then the request can specify how often it should be executed and an indication of an execution schedule can be stored along with the request.

Process 400 can also include causing a user interface to be provided at the user device to receive the request at the user device. Also, in response to storing the request, the application server can cause a message to be provided at the user interface confirming that the request was successfully processed. For example, the application server can send a message to the user device for display by a user interface of the user device.

Process 400 can also include retrieving the request from the execution store and submitting the request to an NL engine, such as a large language model. The NL engine can also be provided an indication of an access mode to the one or more data sources. For example, the access mode can be a database or an intermediate data source provided, for example, by the execution of a data connector. The access mode can include an indicator for a data connector such that the NL engine can execute the data connector using the user's credentials and analyze the data according to the request. In such embodiments, the NL engine may obtain information from the one or more data sources via the access mode, the obtained information corresponding to the one or more metrics, and the NL engine can determine whether the obtained information satisfies the condition. When the obtained information satisfies the condition, a notification can be triggered by the NL engine to cause a corresponding a notification to appear at the user device indicating that the condition was satisfied. The notification at the user device can cause a physical state of the user device to change, such as a light emitting diode associated with a screen of the user device to change colors or brightness, or such as causing a memory cell associated with the user device to change states.

Process 400 can also include flagging a record in the execution store corresponding to the request as having been satisfied to disable the request from executing again. Process 400 can also include, prior to submitting the request to the NL engine, verifying that an user account associated with the request has permission to access the one or more data sources.

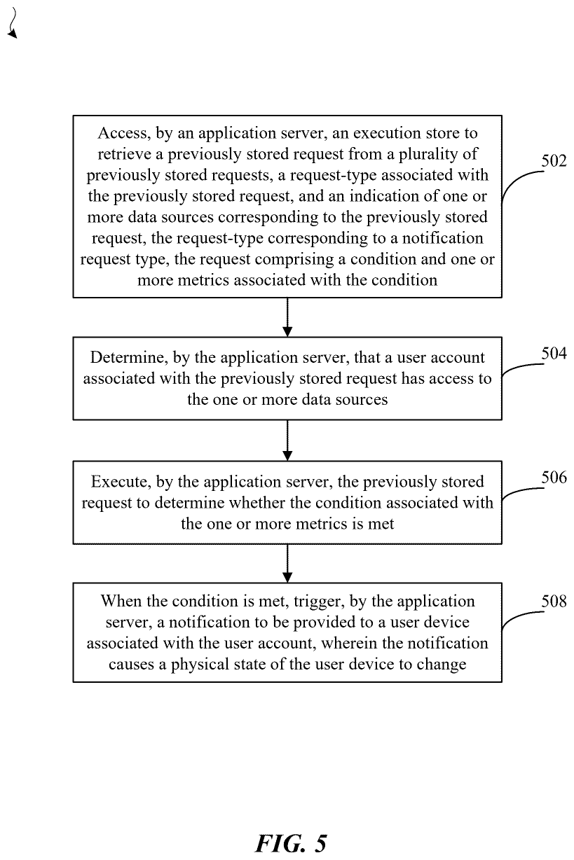

FIG. 5 illustrates a flow diagram of an example process 500 for providing from a server, such as the organization server 104, a mechanism for processing requests from users, in accordance with the subject technology. For explanatory purposes, the process 500 is primarily described herein with reference to the organization server 104. However, the process 500 is not limited to these, and one or more blocks of the process 500 may be performed by one or more other by other suitable devices. Further, for explanatory purposes, the blocks of the process 500 are described herein as occurring sequentially or linearly. However, multiple blocks of the process 500 may occur in parallel. In addition, the blocks of the process 500 need not be performed in the order shown and/or one or more blocks of the process 500 need not be performed and/or can be replaced by other operations.

At block 502, process 500 may include accessing, by an application server, an execution store to retrieve a previously stored request from a plurality of previously stored requests, a request-type associated with the previously stored request, and an indication of one or more data sources corresponding to the previously stored request, the request-type corresponding to a notification request type, the request having a condition and one or more metrics associated with the condition. Block 502 may correspond to element 344 of FIG. 3. For example, a watcher process can initiate the execution of the previously stored request by retrieving it from the execution store. The request-type can correspond to an alert, notification, report, and so forth, and in this example is a notification request, however, another request-type may be used. The condition can be an aspect of the request that is to provide a response with the condition is met when compared to metrics referenced in the request. The request may also or instead correspond to a report or message based on an aggregate of data, such as described above with reference to examples one and two discussed above.

At block 504, process 500 may include determining, by the application server, that a user account associated with the previously stored request has access to the one or more data sources. Block 504 can correspond to element 346 of FIG. 3. The data sources associated with the request can be checked to ensure the user has permission to access them. As noted above, permissions associated with the user may have been changed since the request was last executed.

At block 506, process 500 may include executing, by the application server, the previously stored request to determine whether the condition associated with the one or more metrics is met. Block 506 can correspond to element 350 of FIG. 3. In particular, in some implementations, the request can be provided to an NL engine for evaluation. In addition, a subset of data may also be provided to the NL engine for use in the evaluation. The NL engine can utilize a math plugin to perform calculations for the evaluation. In some implementations, an indicator for the data sources can be provided to the NL engine and the data sources can be accessed by the NL engine using the user's credentials.

At block 508, process 500 may include, when the condition is met, triggering, by the application server, a notification to be provided to a user device associated with the user account, where the notification causes a physical state of the user device to change, such as a light emitting diode associated with a screen of the user device to change colors or brightness, or such as causing a memory cell associated with the user device to change states. In some implementations, the notification can cause an interruption event associated with the user device, such as a locally generated alert or notification to be provided at the user device. It should be understood that other requests can cause other output to be provided to the user, such as other messages or reports, as described above. In some implementations, the notification can trigger on the user device a physical activation of an actuator to cause a haptic sensation to the user, such as a vibration.

Process 500 may further include in some implementations, that the determining that the user account associated with the previously store request includes: determining that the user account has permission to access the one or more data sources, where the user account was determined to previously have permission to access the one or more data sources when the request was previously stored, such as described above with respect to element 314 of FIG. 3.

Process 500 may also include in some implementations, that executing the request includes: providing the request, data from the one or more data sources, and the request-type to a NL engine, such as a large language model, where the NL engine parses the request and the data to determine whether a condition on a metric derived from the request is satisfied by the data. In such implementations, the NL engine can be updated in an intervening time between when the request was last processed, for example, in a previous iteration of process 500. Thus, the NL engine can advantageously provide updated processing without having to update the request itself.

Process 500 may further include that the large language model executes a math library to perform calculations on the data to determine whether the condition on the metric is satisfied by the data. Process 500 may also include enabling a watcher process, such as the watcher process 342, to access the execution store to retrieve the previously stored request when a predetermined condition has been met. The predetermined condition can correspond to a timeout period or a time since last execution, such as when a request is evaluated at predetermined intervals, such as every hour, or every day, and do forth. The predetermined condition can correspond to a periodically implemented request specified by the user, such as generating a report every week or every month.

Process 500 may also include that, after executing the request to determine whether the condition for the metric is met, advancing the watcher process to execute another request previously stored in the execution store. The watcher process can therefore include internally looping on the various requests which may be retrieved and executed. If a condition, such as a periodic condition has not been met, then the watcher process can skip over the request to be executed when the condition has been met.

FIG. 6 depicts an example electronic system 600 with which aspects of the present disclosure may be implemented, in accordance with one or more embodiments. The electronic system 600 can be, and/or can be a part of, any electronic device for generating the features and processes described in reference to FIGS. 1-8, including but not limited to a laptop computer, tablet computer, smartphone, and wearable device (e.g., smartwatch, fitness band). The electronic system 600 may include various types of computer-readable media and interfaces for various other types of computer-readable media. The electronic system 600 includes one or more processing unit(s) 614, a persistent storage device 602, a system memory 604 (and/or buffer), an input device interface 606, an output device interface 608, a bus 610, a ROM 612, one or more processing unit(s) 614, one or more network interface(s) 616, and/or subsets and variations thereof.

The bus 610 collectively represents all system, peripheral, and chipset buses that communicatively connect the numerous internal devices of the electronic system 600. In one or more embodiments, the bus 610 communicatively connects the one or more processing unit(s) 614 with the ROM 612, the system memory 604, and the persistent storage device 602. From these various memory units, the one or more processing unit(s) 614 retrieves instructions to execute and data to process in order to execute the processes of the subject disclosure. The one or more processing unit(s) 614 can be a single processor or a multi-core processor in different embodiments.

The ROM 612 stores static data and instructions that are needed by the one or more processing unit(s) 614 and other modules of the electronic system 600. The persistent storage device 602, on the other hand, may be a read-and-write memory device. The persistent storage device 602 may be a non-volatile memory unit that stores instructions and data even when the electronic system 600 is off. In one or more embodiments, a mass-storage device (such as a magnetic or optical disk and its corresponding disk drive) may be used as the persistent storage device 602.

In one or more embodiments, a removable storage device (such as a floppy disk, flash drive, and its corresponding disk drive) may be used as the persistent storage device 602. Like the persistent storage device 602, the system memory 604 may be a read-and-write memory device. However, unlike the persistent storage device 602, the system memory 604 may be a volatile read-and-write memory, such as RAM. The system memory 604 may store any of the instructions and data that one or more processing unit(s) 614 may need at runtime. In one or more embodiments, the processes of the subject disclosure are stored in the system memory 604, the persistent storage device 602, and/or the ROM 612. From these various memory units, the one or more processing unit(s) 614 retrieves instructions to execute and data to process in order to execute the processes of one or more embodiments.

The bus 610 also connects to the input device interfaces 606 and output device interfaces 608. The input device interface 606 enables a user to communicate information and select commands to the electronic system 600. Input devices that may be used with the input device interface 606 may include, for example, alphanumeric keyboards, touch screens, and pointing devices. The output device interface 608 may enable the electronic system 600 to communicate information to users. For example, the output device interface 608 may provide the display of images generated by electronic system 600. Output devices that may be used with the output device interface 608 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The bus 610 also couples the electronic system 600 to one or more networks and/or to one or more network nodes through the one or more network interface(s) 616. In this manner, the electronic system 600 can be a part of a network of computers (such as a local area network, a wide area network, an intranet, or a network of networks, such as the internet). Any or all components of the electronic system 600 can be used in conjunction with the subject disclosure.

Embodiments within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be re-arranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, an embodiment, the embodiment, another embodiment, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
decoding, at an application server, a monitoring request from a user device to determine a request-type, the monitoring request comprising a targeting condition and one or more metrics indicating whether the targeting condition is satisfied;
matching, by the application server, the monitoring request to one or more data sources based at least in part on the one or more metrics and the request-type;
determining, by the application server, that the user device is associated with a user account having access permissions to each of the one or more data sources associated with the one or more metrics; and
storing, by the application server, the request-type and the request in an execution store, wherein the monitoring request is later retrieved from the execution store and executed to determine whether the targeting condition for the one or more metrics is satisfied, wherein a message is provided to the user device when the targeting condition is satisfied.

2. The method of claim 1, wherein the monitoring request is formatted in a natural language format.

3. The method of claim 1, wherein the request-type of the monitoring request corresponds to a notification request.

4. The method of claim 1, further comprising:
submitting the monitoring request to a large language model at the application server to obtain the request-type, the targeting condition, the one or more metrics, and the one or more data sources, wherein the large language model was previously trained with a mapping of the one or more data sources; and
deriving metric typing information from the request-type and the one or more metrics.

5. The method of claim 4, wherein the metric typing information corresponds to a first group and a functional space of the first group, wherein the one or more data sources are constrained to data sources related to the first group and the functional space of the first group.

6. The method of claim 1, further comprising:
categorizing the monitoring request as being event-based or time-based; and
storing the categorization of the monitoring request in the execution store.

7. The method of claim 1, further comprising:
causing a user interface to be provided at the user device to receive the monitoring request at the user device; and
in response to storing the monitoring request, causing a message to be provided at the user interface confirming that the monitoring request was successfully processed.

8. The method of claim 1, further comprising:
retrieving the monitoring request from the execution store;
submitting the monitoring request to a large language model and an indication of an access mode to the one or more data sources, the large language model obtaining information from the one or more data sources via the access mode, the obtained information corresponding to the one or more metrics, the large language model determining whether the obtained information satisfies the targeting condition; and
when the obtained information satisfies the targeting condition, triggering a notification at the user device indicating that the targeting condition is satisfied.

9. The method of claim 8, further comprising:
flagging a record in the execution store corresponding to the monitoring request as being satisfied to disable the monitoring request from executing again.

10. The method of claim 8, further comprising:
prior to submitting the monitoring request to the large language model, verifying that a user account associated with the monitoring request has permission to access the one or more data sources.

11. A method comprising:
accessing, by an application server, an execution store to retrieve a previously stored request from a plurality of previously stored requests, a request-type associated with the previously stored request, and an indication of one or more data sources corresponding to the previously stored request, the request-type corresponding to a notification request type, the request comprising a condition and one or more metrics associated with the condition;
determining, by the application server, that a user account associated with the previously stored request has access to the one or more data sources;
executing, by the application server, the previously stored request to determine whether the condition associated with the one or more metrics is met; and
when the condition is met, triggering, by the application server, a notification to be provided to a user device associated with the user account, wherein the notification causes a physical state of the user device to change.

12. The method of claim 11, wherein determining that the user account associated with the previously stored request comprises determining that the user account has permission to access the one or more data sources, wherein the user account was determined to previously have permission to access the one or more data sources when the previously stored request was previously stored.

13. The method of claim 11, wherein executing the previously stored request comprises:
providing the previously stored request, data from the one or more data sources, and the request-type to a large language model, wherein the large language model parses the previously stored request and the data to determine whether the condition associated with the condition is met by the data.

14. The method of claim 11, further comprising:
enabling a watcher process to access the execution store to retrieve the previously stored request when a predetermined condition has been met.

15. The method of claim 14, wherein the predetermined condition corresponds to a timeout period.

16. The method of claim 11, wherein the notification causes an illumination state to change of one or more light emitting diodes or a physical activation of a vibrating device.

17. A non-transitory computer-readable medium storing instructions thereon, which when executed by one or more processors, cause the one or more processors to perform a method comprising:
decoding a monitoring request from a user device to determine a request-type, the monitoring request comprising a targeting condition and one or more metrics indicating whether the targeting condition is satisfied;
matching the monitoring request to one or more data sources based at least in part on the one or more metrics and the request-type;
storing the request-type and the monitoring request in an execution store, wherein the monitoring request is later retrieved from the execution store and executed to determine whether the targeting condition for the one or more metrics is satisfied, wherein a message is provided to the user device when the targeting condition is satisfied;
accessing the execution store to retrieve a previously stored request from a plurality of previously stored requests, a request-type associated with the previously stored request, and an indication of the one or more data sources corresponding to the previously stored request, the request-type corresponding to a notification request type, the previously stored request comprising the targeting condition and the one or more metrics associated with the targeting condition;
determining that a user account associated with the previously stored request has access to the one or more data sources;
executing the previously stored request to determine whether the targeting condition associated with the one or more metrics is satisfied; and
when the targeting condition is satisfied, triggering a notification to be provided to a user device associated with the user account, wherein the notification causes a physical state of the user device to change.

18. The non-transitory computer-readable medium of claim 17, wherein the instructions further cause the one or more processors to:
periodically review the execution store and process other previously stored requests.

19. The non-transitory computer-readable medium of claim 17, wherein the previously stored request corresponds to the monitoring request.

20. The non-transitory computer-readable medium of claim 17, wherein the instructions further cause the one or more processors to:
executing the monitoring request prior to storing the monitoring request in the execution store to determine whether the targeting condition associated with the one or more metrics is satisfied; and
when the targeting condition is not satisfied, storing the monitoring request in the execution store in response to the targeting condition not being satisfied.
